(19) United States
(12) Patent Application Publication
(10) Pub. No.: US 2015/0375151 A1
(43) Pub. Date: Dec. 31, 2015

(54) AIR FILTER FOR COLLECTING DEBRIS IN AN AIRCRAFT VENTILATION DUCT

(71) Applicant: AIRBUS OPERATIONS (S.A.S.), Toulouse (FR)

(72) Inventors: David Wydler, NOUGAROULET (FR); Jean-Christophe Bisinotto, TOULOUSE (FR)

(21) Appl. No.: 14/747,335

(22) Filed: Jun. 23, 2015

(30) Foreign Application Priority Data
Jun. 25, 2014 (FR) 1455890

(51) Int. Cl. B01D 46/00

(52) U.S. Cl. CPC B01D 46/0005

(57) ABSTRACT

The disclosure herein includes an air filter for an aircraft ventilation duct, the duct including an upstream pipe and a downstream pipe in line with the upstream pipe the air filter including a screen with an outside diameter greater than the outside diameters of the upstream pipe and the downstream pipe and a clamp with an interior surface that surrounds the screen and extends to either side of the screen, the interior surface including a groove configured to receive at least partially a peripheral rim of the screen. The disclosure herein also includes ventilation duct equipped with the air filter and a method of collecting debris in an aircraft ventilation duct that uses an air filter according to the disclosure herein.

### CROSS-REFERENCE TO RELATED APPLICATION

This application claims priority to French patent application FR 14 55890 filed Jun. 25, 2014, the entire disclosure of which is incorporated by reference herein.

### TECHNICAL FIELD

The present disclosure relates to an air filter for collecting debris in an aircraft ventilation duct.

### BACKGROUND

As shown in FIG. 1, an aircraft ventilation network includes at least one aspiration system 10 that includes at least one aspiration inlet 12 connected to an upstream network 14 and at least one outlet 16 connected to a downstream network 18.

The upstream and downstream networks 14 and 18 include numerous elements such as diffusers, ducts, air conditioning systems, supports, for example.

In accordance with one assembly method, two adjacent sections of the ventilation network are connected by a clamp 20 that straddles the two sections on the outside. This clamp 20 also provides the seal from one section to the other. This clamp 20 generally takes the form of a collar that encircles the two sections and includes a clamping system so that the clamp 20 exerts a constriction force on the sections.

Despite the precautions taken during installation, foreign bodies 22 may be present in the upstream network 14.

During tests, these foreign bodies 22 are aspirated by the aspiration system 10 which causes ground up particles 24 to be diffused in the downstream network 18 as far as the diffusers disposed in the cabin of the aircraft. Another disadvantage is that these foreign bodies 22 can damage the aspiration system 10 or other elements of the downstream network 18. Any such damage impacts on production costs because of the elements to be replaced but also on the progress of the aircraft along the production line.

### SUMMARY

The present disclosure aims to remedy the drawbacks of the prior art. To this end, the disclosure herein comprises an air filter for an aircraft ventilation duct, the duct comprising an upstream pipe and a downstream pipe in line with the upstream pipe. The air filter includes a screen with an outside diameter greater than the outside diameters of the upstream pipe and the downstream pipe and a clamp with an interior surface that surrounds the screen and extends to either side of the screen, the interior surface including a groove configured to receive at least partially a peripheral rim of the screen.

The air filter is installed before the tests. It makes it possible to retain the foreign bodies and limits the risk of damage to elements of the ventilation network.

The screen and the clamp are advantageously separate. This configuration simplifies fitting the air filter in that the screen and the clamp are installed one after the other.

The screen advantageously includes a peripheral rim of annular shape and a central mesh. In accordance with one embodiment, the central mesh is thinner than the peripheral rim.

In accordance with another feature, the clamp comprises at least two portions that when placed end-to-end surround the upstream and downstream pipes. This configuration makes it possible to install the air filter without demounting the upstream and downstream pipes. In accordance with one embodiment, the portions of the clamp are articulated to one another, two of them being connected by a tensioning mechanism.

In accordance with another feature, the air filter includes two compression bands positioned at the level of the interior surface on either side of the screen. The compression bands improve the distribution of the forces exerted by the clamp on the pipes and make it possible to limit the risks of damaging the pipes. The compression bands are advantageously made from a non-porous material. The compression bands therefore also provide the sealing function.

In accordance with one embodiment, the clamp has an interior surface with two grooves adapted to accommodate partially the sealing bands.

The disclosure herein also comprises an aircraft ventilation duct equipped with an air filter in accordance with the disclosure herein.

The disclosure herein further comprises a method of collecting debris in an aircraft ventilation duct that uses an air filter in accordance with the disclosure herein. This method comprises inserting the screen between upstream and downstream pipes and surrounding the screen and the upstream and downstream pipes with the clamp.

### BRIEF DESCRIPTION OF THE DRAWINGS

Other features and advantages will emerge from the following description of the disclosure herein given way of example only and with reference to the appended drawings, in which:

FIG. 1 is a longitudinal section of a part of an aircraft ventilation network that illustrates the prior art;

FIG. 2 is a longitudinal section of a part of an aircraft ventilation network that illustrates the disclosure herein;

FIG. 3 is a front view of a screen of an air filter that illustrates one embodiment of the disclosure herein;

FIG. 4 is a perspective view of a clamp of an air filter that illustrates one embodiment of the disclosure herein;

FIG. 5A is a perspective view of the screen from FIG. 3 and the clamp from FIG. 4 during assembly; and

FIG. 5B is a perspective view of the screen from FIG. 3 and the clamp from FIG. 4 when assembled.

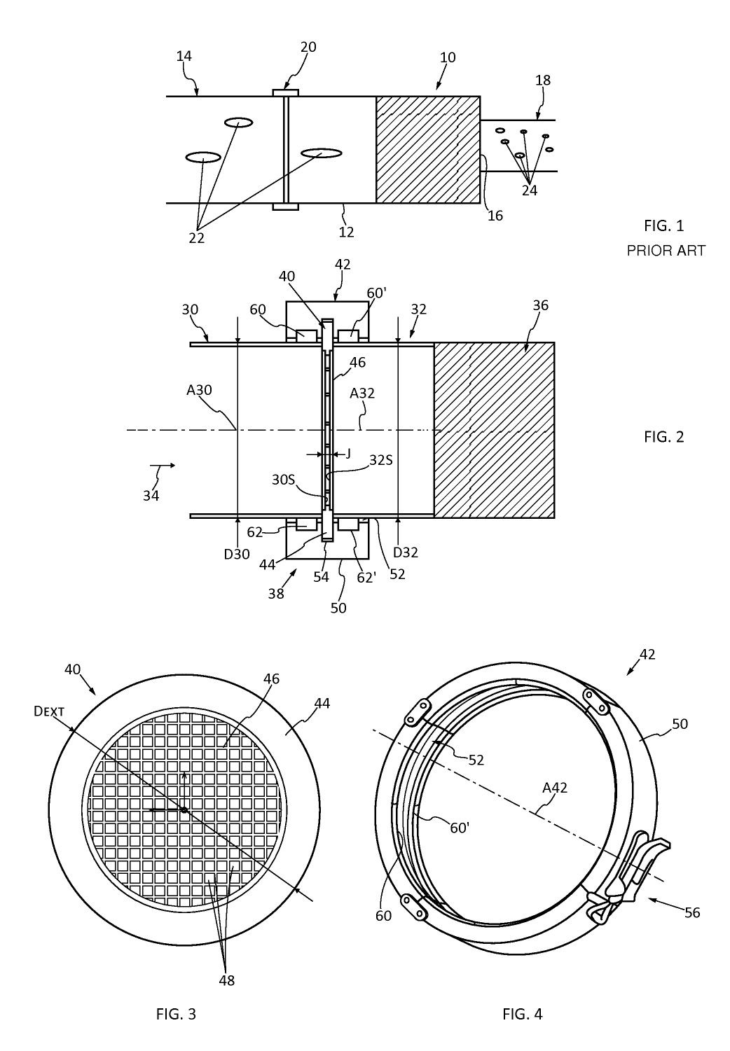

### DETAILED DESCRIPTION

In FIG. 2 there is represented a part of an aircraft ventilation network that includes an upstream pipe 30 and a downstream pipe 32 in line with the upstream pipe 30 to form an air duct. The direction of flow of the air is represented by an arrow 34.

The upstream circular cylindrical pipe 30 and the downstream circular cylindrical pipe 32 have aligned axes A30 and A32, coaxial exterior surfaces and outside diameters D30 and D32 that are approximately identical.

For the remainder of the description, the longitudinal direction is parallel to the axes A30 and A32 of the pipes and to the direction 34 of flow of the air. A transverse plane is perpendicular to the longitudinal direction. A radial direction is perpendicular to the longitudinal direction.

For example, the downstream pipe 32 is an aspiration inlet of an aspiration system 36. The disclosure herein is not limited to this arrangement, however. In accordance with one embodiment, the upstream pipe 30 and the downstream pipe 32 are made from composite materials.

The upstream pipe 30 includes an upstream junction surface 30S and the downstream pipe 32 includes a downstream junction surface 32S. The upstream junction surface 30S and the downstream junction surface 32S are approximately parallel and disposed in transverse planes. They are spaced by a clearance J that varies from one aircraft to another. This clearance J is between 3 and 15 mm.

In accordance with the disclosure herein, an air filter 38 is positioned in the junction area of the upstream pipe 30 and the downstream pipe 32. This air filter 38 comprises a screen 40 and a clamp 42 that are separate and can be separated, the screen 40 being inserted between the upstream junction surface 30S and the downstream junction surface 32S of the upstream pipe 30 and the downstream pipe 32, the clamp 42 straddling and surrounding the upstream pipe 30 and the downstream pipe 32.

The screen 40 is preferably a disk with a thickness less than or equal to the clearance J. In accordance with one embodiment, the screen 40 has a thickness of the order of 3 mm so that it can be inserted between the junction surfaces 30S and 32S of the upstream pipe 30 and the downstream pipe 32, regardless of the aircraft.

In accordance with one embodiment, the screen 40 is made of metal. The screen 40 includes a solid peripheral rim 44 of annular shape and a central mesh 46. By solid is meant that the peripheral rim does not include any air passage sections.

The peripheral rim 44 has a thickness of the order of 3 mm. It extends over a width in a radial direction of the order of 5 to 20 mm. In accordance with one embodiment, the peripheral rim 44 has an outside diameter that exceeds the outside diameter of the pipe 30 by approximately 17 mm.

The central mesh 46 is preferably thinner than the peripheral rim 44. In accordance with one embodiment, the central mesh 46 has a thickness of the order of 2 mm and a diameter of the order of 230 mm.

The central mesh 46 is advantageously centred relative to the thickness of the peripheral rim 44. The central mesh 46 is sized so as not to generate excessive head losses in the flow of air. Thus the central mesh 46 comprises a plurality of passage sections separated by strips 48 of material. In accordance with one embodiment, the passage sections are square and the strips 48 of material are rectilinear and oriented in two perpendicular directions.

The section of the strips of material in a transverse plane is adjusted so as to obtain a compromise between as high as possible a mechanical strength of the mesh in order to retain the foreign bodies and aerodynamic characteristics that limit disturbances to the flow of air.

For example, the passage sections have a square section with a side length of the order of 10 to 15 mm and the strips 48 of material have a width of the order of 2 mm.

The screen 40 has an outside diameter DEXT greater than the outside diameters D30, D32 of the upstream pipe 30 and the downstream pipe 32.

The clamp 42 has a cylindrical exterior surface 50 and a cylindrical interior surface 52, the exterior surface 50 and the interior surface 52 being coaxial with a clamp axis A42 that approximately coincides with the axes A30 and A32 of the upstream pipe 30 and the downstream pipe 32 when the clamp is mounted on the pipes.

The clamp 42 is configured so that the interior surface 52 surrounds the screen 40 and extends to either side of the screen 40. As a result, the clamp 42 surrounds on either side the screen 40, the upstream pipe 30 and the downstream pipe 32.

The clamp 42 includes a groove 54 in the interior surface 52 configured to receive at least partially the peripheral rim 44. This groove 54 makes it possible to immobilize the clamp 42 relative to the screen 40 in the longitudinal direction. The groove 54 preferably has a width identical to the thickness of the screen 40. The interior surface 52 of the clamp 42 has a diameter less than the outside diameter DEXT of the screen 40. When the clamp is mounted on the upstream pipe 30 and the downstream pipe 32, the bottom of the groove 54 has a diameter equal to or very slightly greater than the outside diameter DEXT of the screen 40.

The clamp 42 advantageously comprises at least two portions which when placed end-to-end surround the upstream pipe 30 and the downstream pipe 32. This solution makes it possible to be able to mount the clamp around the upstream pipe 30 and the downstream pipe 32 without demounting them.

The portions of the clamp are preferably articulated to one another, two of them being connected by a tensioning mechanism 56.

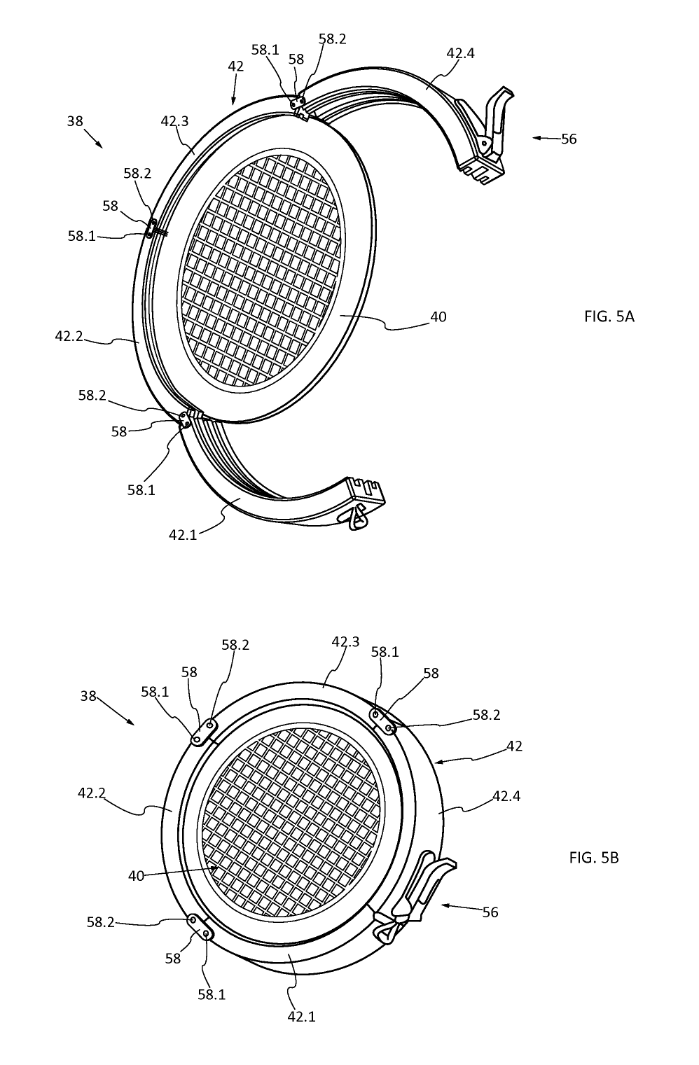

In accordance with an embodiment shown in FIGS. 4, 5A and 5B, the clamp 42 comprises four portions 42.1 to 42.4, each portion extending over a quarter-circle.

The portions 42.1 to 42.4 are preferably articulated two-by-two so as to obtain a series of portions of which the end portions 42.1 and 42.4 are connected by a tensioning mechanism 56.

In accordance with one embodiment, two adjacent portions are connected by two parallel lugs 58 disposed on either side of the clamp 42, at the level of its edge surfaces. Each lug 58 has at a first end a pivoting connection 58.1 for connecting it to a first portion and at a second end a pivoting connection 58.2 for connecting it to a second portion. These pivoting connections 58.1 and 58.2 are parallel to each other and parallel to the clamp axis A42.

The portions 42.1 and 42.4 are connected by a tensioning mechanism 56 such as a toggle type hook, for example. This tensioning mechanism 56 makes it possible to exert a traction force on the portions 42.1 to 42.4 that is converted into a constriction force of the clamp 42 on the upstream pipe 30 and the downstream pipe 32. The greater the number of portions, the more homogeneous the distribution of the constriction force exerted by the clamp 42 on the upstream pipe 30 and the downstream pipe 32 over the circumference of the pipes.

In accordance with another feature, the air filter includes two compression bands 60, 60′, a first compression band 60 inserted between the clamp 42 and the upstream pipe 30 and a second compression band 60′ inserted between the clamp 42 and the downstream pipe 32. These compression bands 60, 60′ are compressed between the clamp 42 and the pipes and make possible an improved distribution of the constriction force exerted by the clamp 42 on the upstream pipe 30 and the downstream pipe 32.

In accordance with one embodiment, each compression band 60, 60′ comprises a plurality of separate sections, one section for each clamp portion. The compression bands 60, 60′ are preferably made from a non-porous material and contribute to improving the seal between the clamp 42 and the upstream pipe 30 and the downstream pipe 32.

The interior surface 52 of the clamp 42 preferably includes two grooves 62, 62′ disposed on either side of the groove 54 for the screen to house the compression bands 60, 60′ partially.

In accordance with an embodiment shown in FIG. 2, the compression bands have a rectangular section and are made of elastomer. Of course, the disclosure herein is not limited to this section or to this material for the compression bands. Any compressible and non-porous material could therefore be suitable.

Fitting the air filter 38 is simple and easy. Firstly, the screen 40 is inserted between the junction surfaces 30S and 32S of the upstream pipe 30 and the downstream pipe 32. Next, as shown in FIG. 5A, the clamp 42 is fitted around the upstream pipe 30 and the downstream pipe 32. Finally, the portions 42.1 and 42.4 are connected by a tensioning mechanism as shown in FIG. 5B. After fitting, only the compression bands 60, 60′ are in contact with the upstream pipe 30 and the downstream pipe 32, which tends to reduce the risk of damaging the pipes 30 and 32.

Another advantage is that the air filter can be removed easily, by firstly demounting the clamp 42 and then removing the screen 40. When it has been removed, the foreign bodies can be removed.

In accordance with another feature, the air filter is used like a tool, i.e. it does not remain permanently inserted between two portions of an aircraft ventilation network. It may be installed temporarily on a duct of the ventilation network, for example during testing of the ventilation network during the construction of the aircraft. It may be reinstalled subsequently.

Alternatively, the air filter remains inserted between the two portions of an aircraft ventilation network and is demounted only to clean the screen 40 and to remove any foreign bodies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An air filter for an aircraft ventilation duct, the duct comprising an upstream pipe and a downstream pipe in line with the upstream pipe, the air filter comprising a screen with an outside diameter greater than the outside diameters of the upstream pipe and the downstream pipe and a clamp with an interior surface that surrounds the screen and extends to either side of the screen, the interior surface including a groove configured to receive at least partially a peripheral rim of the screen.

2. The air filter according to claim 1, wherein the screen and the clamp are separate.

3. The air filter according to claim 1, wherein the screen includes a peripheral rim of annular shape and a central mesh.

4. The air filter according to claim 3, wherein the central mesh is thinner than the peripheral rim.

5. The air filter according to claim 1, wherein the clamp comprises at least two portions that when placed end-to-end surround the screen.

6. The air filter according to claim 5, wherein the portions of the clamp are articulated to one another, two of them being connected by a tensioning mechanism.

7. The air filter according to claim 1, wherein the air filter includes two compression bands positioned at the level of the interior surface on either side of the screen.

8. The air filter according to claim 7, wherein the compression bands are made from a non-porous material.

9. The air filter according to claim 7, wherein the clamp has an interior surface with two grooves adapted to accommodate partially the compression bands.

10. The aircraft ventilation duct, the duct comprising an upstream pipe and a downstream pipe in line with the upstream pipe and an air filter according to claim 1, wherein the air filter comprises:
a screen with an outside diameter greater than the outside diameters of the upstream pipe and the downstream pipe, disposed between the upstream pipe and the downstream pipe, and
a clamp straddling the upstream pipe and the downstream pipe and surrounding them, the clamp having an interior surface hat includes a groove configured to receive at least partially a peripheral rim of the screen.

11. The method of collecting debris in an aircraft ventilation duct using an air filter according to claim 10, the duct including an upstream pipe and a downstream pipe in line with the upstream pipe, the method comprising inserting a screen with an outside diameter greater than the outside diameters of the upstream pipe and the downstream pipe, surrounding the screen and the upstream pipe and the downstream pipe with a clamp that has an interior surface with a groove configured to receive at least partially a peripheral rim of the screen.
